(19) United States
(12) Patent Application Publication
(10) Pub. No.: US 2017/0315676 A1
(43) Pub. Date: Nov. 2, 2017

(54) DYNAMIC CONTENT INSERTION

(71) Applicant: Linkedln Corporation, Mountain View, CA (US)

(72) Inventors: Siyu You, Santa Clara, CA (US); Aman Grover, Sunnyvale, CA (US); Christos Koufogiannakis, Menlo Park, CA (US); Manoj Rameshchandra Thakur, Sunnyvale, CA (US)

(21) Appl. No.: 15/141,090

(22) Filed: Apr. 28, 2016

(51) Int. Cl. G06F 3/0481; H04L 12/26; H04L 29/08

(52) U.S. Cl. CPC G06F 3/0481; H04L 67/306; H04L 43/045; H04L 67/02

(57) ABSTRACT

Methods and systems for selecting candidate content for insertion into a content presentation to generate tailored user interface screens are described. According to various embodiments, the system receives a set of publication data including a plurality of content pages with content elements. The system determines a set of content divisions among the content pages and one or more insertion points corresponding to one or more content divisions. The system determines a set of candidate insertion content based on the set of content elements and the insertion points. The system causes presentation of the set of publication data including the plurality of content pages. Upon presentation of a content page proximate to an insertion point, the system selects a candidate insertion content item for insertion into the insertion point and causes presentation of the candidate insertion content during presentation of the set of publication data.

### TECHNICAL FIELD

The present disclosure generally relates to the technical field of network-based publication systems and, in one embodiment, to analyzing sets of content on network-based publication systems for insertion of additional content during presentation of the sets of content to generate tailored user interface presentations.

### BACKGROUND

Network-based publication systems enable users to publish documents, pages, and other content. Users may access and view published content on the network-based publication system via a network linking the network-based publication system to a client device. A social networking system, such as LinkedIn, may allow members to declare information about themselves, such as their professional qualifications or skills. In addition to information the members declare about themselves, a social networking system may gather and track information pertaining to behaviors of members with respect to the social networking system and social networks of members of the social networking system. Analyzing a vast array of such information may help to come up with solutions to various problems that may not otherwise have clear solutions.

### BRIEF DESCRIPTION OF THE SEVERAL VIEWS OF THE DRAWINGS

Some embodiments are illustrated by way of example and not limitation in the accompanying drawings, in which:

FIG. 1 is a block diagram of the functional components or components that comprise a computer-network based social network service, including a content insertion machine consistent with some embodiments described herein;

FIG. 2 is a block diagram depicting some example components of the content insertion machine of FIG. 1;

FIG. 3 is a flow diagram illustrating an example method of dynamically selecting candidate content for insertion into a content presentation, according to some embodiments of the present disclosure;

FIG. 4 is a flow diagram illustrating an example method of dynamically selecting candidate content for insertion into a content presentation, according to some embodiments of the present disclosure;

FIG. 5 is a flow diagram illustrating an example method of dynamically selecting candidate content for insertion into a content presentation, according to some embodiments of the present disclosure;

FIG. 6 is a flow diagram illustrating an example method of dynamically selecting candidate content for insertion into a content presentation, according to some embodiments of the present disclosure;

FIG. 7 is a flow diagram illustrating an example method of dynamically selecting candidate content for insertion into a content presentation, according to some embodiments of the present disclosure;

FIG. 8 is a flow diagram illustrating an example method of dynamically selecting candidate content for insertion into a content presentation, according to some embodiments of the present disclosure;

FIG. 9 is a block diagram of a machine in the form of a computing device within which a set of instructions, for causing the machine to perform any one or more of the methodologies discussed herein, may be executed.

### DETAILED DESCRIPTION

Example methods and systems for automatically detecting insertion points within a set of publication data and insertion of additional content are described. In some example embodiments, slide decks (e.g., a set of publication data) may be received by a social networking system or network-based publication system. The methods and systems described herein enable additional content pages (e.g., slides or content rendered to appear as a slide) to be presented within the slide deck in an unobtrusive manner without permanently altering the underlying slide deck. The additional content may be selected based on topics, keywords, or interests similar to those presented within the slide deck. In this way, a member's user experience during presentation of the slide deck may be preserved.

As described in the methods and systems within the present disclosure, when a member uploads a slide deck to a website (e.g., the social networking system or the network-based publication system), the slides are processed to identify keywords, topics, and insertion points for additional content. The keywords and topics may be identified automatically from the content of the slide deck using the methods and systems in the present disclosure. In some instances, the keywords and topics may be identified based on metadata associated with the slide deck. For example, the slide deck may include metadata indicating labels for slides within the slide deck, sections of linked slides within the slide deck, or portions of the slide deck identified by a table of contents. The metadata may also include a predefined taxonomy of the slides uploaded by the member. Members may be prompted to add keywords which best describe, in the uploading member's estimation, the gist of the slides or overall slide deck. The methods and systems described herein may also automatically identify and associate keywords where none are provided by the member or those keywords provided are inaccurate or inadequate.

Insertion points may be identified based on divisions between slides, sections among the slides of the slide deck, the table of contents, and keywords. The insertion points may be automatically identified, as described below, using one or more methods. Additional content may be dynamically inserted within the slide deck at insertion points during presentation of the slide deck at a computing device of the member. The insertion points may be identified between slides from two distinct sections of a slide deck or having two distinct topics.

The systems and methods described herein may determine additional content for inclusion, render the additional content in an appropriate style for the slide deck, and present the additional material within the procession of the slides using triggers. The triggers cause the identification and processing of the additional content for presentation such that the slide deck and inserted additional content may be presented in an uninterrupted and smooth manner with respect to the browsing experience of the member. The uninterrupted browsing experience may present slides of the slide deck and rendered additional content with no perceivable delay.

Social networking services provide various profile options and services. In some instances, a social network may connect members (e.g., individuals associated with the social network) and organizations alike. Social networking services have also become a popular method of performing organizational research and job searching. Job listings representing openings (e.g., employment and volunteer positions) within an organization may be posted and administered by the organization or third parties (e.g., recruiters, employment agencies, etc.).

A social networking system may have a vast array of information pertaining to members of the social networking system, companies maintaining a social networking presence on the social networking system, and interactions between members, companies, and content provided by both the members and companies to the social networking system. As will be discussed in more detail below, information pertaining to members of the social networking system can include data items pertaining to education, work experience, skills, reputation, certifications, other qualifications of each of the members of the social networking system at particular points during the careers of these members, or interaction data indicating a history of interactions with content on the social networking system. This information pertaining to members of the social networking system may be member generated to enable individualization of social networking profiles as well as to enable dynamic and organic expansion and discovery of fields of experience, education, skills, and other information relating to personal and professional experiences of members of the social networking system.

Other aspects of the present inventive subject matter will be readily apparent from the description of the figures that follow.

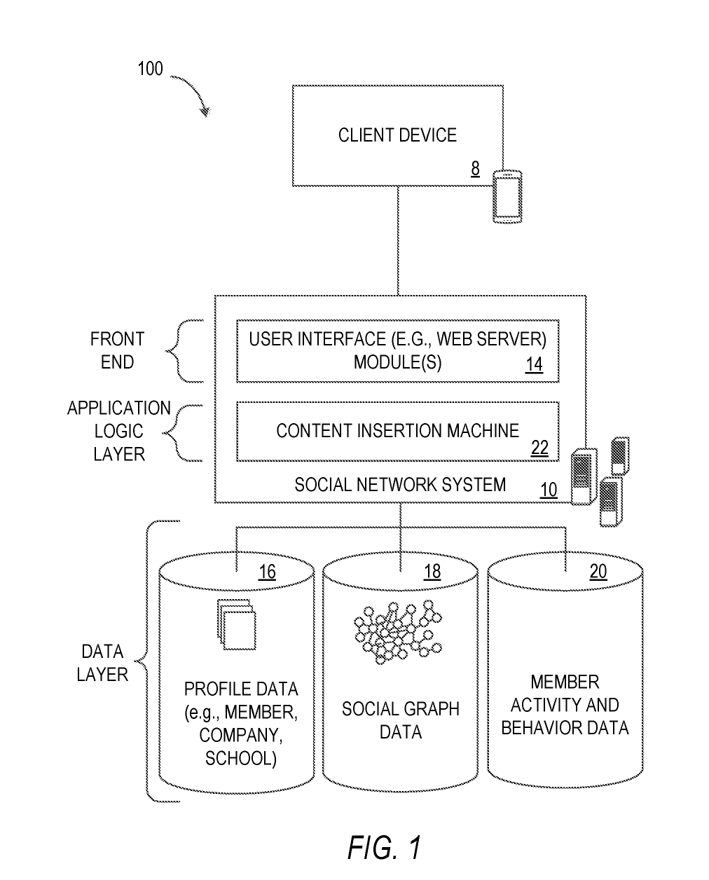

FIG. 1 is a block diagram 100 of the functional components or components that comprise a computer- or network-based social network system 10 consistent with some embodiments of the inventive concepts of the present disclosure. In some embodiments, the social networking system 10 acts as a network-based publication system. In these instances, as shown in FIG. 1, the social networking system 10 is generally based on a three-tiered architecture, comprising a front-end layer, application logic layer, and data layer. As is understood by skilled artisans in the relevant computer and Internet-related arts, each component or engine shown in FIG. 1 represents a set of executable software instructions (e.g., an instruction set executable by a processor) and the corresponding hardware (e.g., memory and processor) for executing the instructions. To avoid obscuring the inventive subject matter, various functional components and engines that are not germane to conveying an understanding of the inventive subject matter have been omitted from FIG. 1. However, a skilled artisan will readily recognize that various additional functional components and engines may be used with a social network system 10, such as that illustrated in FIG. 1, to facilitate additional functionality that is not specifically described herein. Furthermore, the various functional components and engines depicted in FIG. 1 may reside on a single server computer, or may be distributed across several server computers in various arrangements. Moreover, although depicted in FIG. 1 as a three-tiered architecture, the inventive subject matter is by no means limited to such architecture.

As shown in FIG. 1, the front end comprises a user interface component 14 (e.g., a web server), which receives requests from various client-computing devices 8, and communicates appropriate responses to the requesting client devices 8. For example, the user interface component 14 may receive requests in the form of Hypertext Transport Protocol (HTTP) requests, or other web-based, application programming interface (API) requests. The client devices 8 may be executing conventional web browser applications, or applications that have been developed for a specific platform to include any of a wide variety of mobile devices and operating systems.

As shown in FIG. 1, the data layer includes several databases, including one or more databases 16 for storing data relating to various entities represented in a social graph. With some embodiments, these entities include members, companies, and/or educational institutions, among possible others. Consistent with some embodiments, when a person initially registers to become a member of the social network service, and at various times subsequent to initially registering, the person will be prompted to provide some personal information, such as his or her name, age (e.g., birth date), gender, interests, contact information, home town, address, the names of the member's spouse and/or family members, educational background (e.g., schools, majors, etc.), current job title, job description, industry, employment history, skills, professional organizations, and so on. This information is stored as part of a member's member profile, for example, in the database 16. With some embodiments, a member's profile data will include not only the explicitly provided data, but also any number of derived or computed member profile attributes and/or characteristics.

Once registered, a member may invite other members, or be invited by other members, to connect via the social network service. A “connection” may use a bi-lateral agreement by the members, such that both members acknowledge the establishment of the connection. Similarly, with some embodiments, a member may elect to “follow” another member. In contrast to establishing a “connection”, the concept of “following” another member typically is a unilateral operation and, at least with some embodiments, does not include acknowledgement or approval by the member that is being followed. When one member follows another, the member who is following may receive automatic notifications about various activities undertaken by the member being followed. In addition to following another member, a user may elect to follow a company, a topic, a conversation, or some other entity. In general, the associations and relationships that a member has with other members and other entities (e.g., companies, schools, etc.) become part of the social graph data maintained in a database 18. With some embodiments, a social graph data structure may be implemented with a graph database 18, which is a particular type of database that uses graph structures with nodes, edges, and properties to represent and store data. In this case, the social graph data stored in database 18 reflects the various entities that are part of the social graph, as well as how those entities are related with one another.

With various alternative embodiments, any number of other entities might be included in the social graph and, as such, various other databases may be used to store data corresponding with other entities. For example, although not shown in FIG. 1, consistent with some embodiments, the system may include additional databases for storing information relating to a wide variety of entities, such as information concerning various online or offline groups, job listings or postings, photographs, audio or video files, and so forth.

With some embodiments, the social network service may include one or more activity and/or event tracking components, which generally detect various member-related activities and/or events, and then store information relating to those activities/events in the database with reference number 20. For example, the tracking components may identify when a member makes a change to some attribute of his or her member profile, or adds a new attribute. Additionally, a tracking component may detect the interactions that a member has with different types of content. Such information may be used, for example, by one or more recommendation engines to tailor the content presented to a particular member, and generally to tailor the member experience for a particular member.

The application logic layer includes various application server components, which, in conjunction with the user interface component 14, generate various user interfaces (e.g., web pages) with data retrieved from various data sources in the data layer. With some embodiments, individual application server components are used to implement the functionality associated with various applications, services and features of the social network service. For instance, a messaging application, such as an email application, an instant messaging application, a social networking application native to a mobile device, a social networking application installed on a mobile device, or some hybrid or variation of these, may be implemented with one or more application server components implemented as a combination of hardware and software elements. Of course, other applications or services may be separately embodied in their own application server components.

As shown in FIG. 1, a content insertion machine 22 is an example application server component of the social network system 10. The content insertion machine 22 performs operations to automatically and dynamically select candidate content and insert the candidate content into a set of content pages for presentation to a member of the social network system 10. In some embodiments, the content insertion machine 22 operates in conjunction with the user interface components 14 to receive sets of publication data and member input to generate tailored user interface presentations including content pages of the set of publication data and the candidate insertion content. For example, the content insertion machine 22 may render graphical representations of slide decks (e.g., sets of publication data) with periodically inserted candidate insertion content interspersed among the slides. The candidate insertion content may include additional slides from other sets of publication data, slides representing other sets of publication data, advertisements, and other suitable insertion content configured to be presented in a style, form, and color of the slides (e.g., content pages) of the slide deck (e.g., the set of publication data).

The social network system 10 may provide a broad range of applications and services that allow members the opportunity to share and receive information, often customized to the interests of the member. For example, with some embodiments, the social network system 10 may include a photo sharing application that allows members to upload and share photos with other members or a slide sharing application which allows members to upload slide decks for sharing among other members. With some embodiments, members of a social network system 10 may be able to self-organize into groups, or interest groups, organized around a subject matter or topic of interest. Accordingly, the data for a group may be stored in a database (not shown). When a member joins a group, his or her membership in the group will be reflected in the social graph data stored in the database 18. With some embodiments, members may subscribe to or join groups affiliated with one or more companies. For instance, with some embodiments, members of the social network system 10 may indicate an affiliation with a company at which they are employed, such that news and events pertaining to the company are automatically communicated to the members. With some embodiments, members may be allowed to subscribe to receive information concerning companies other than the company with which they are employed. Here again, membership in a group, a subscription or following relationship with a company or group, as well as an employment relationship with a company, are all examples of the different types of relationships that may exist between different entities, as defined by the social graph and modelled with the social graph data of the database 18.

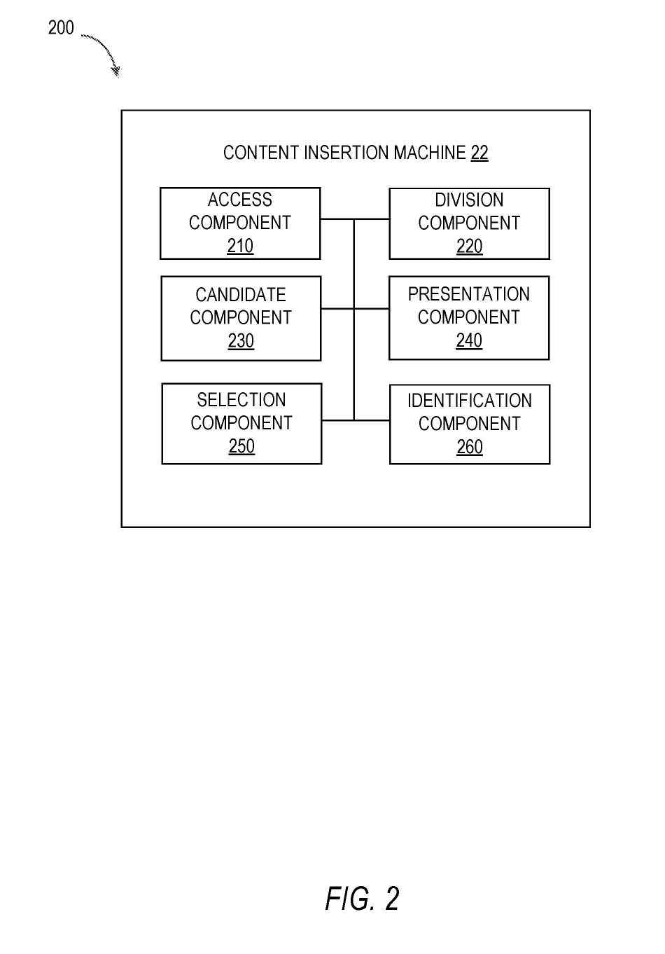

FIG. 2 is a block diagram depicting some example components of the content insertion machine 22 of FIG. 1. The content insertion machine 22 is shown including an access component 210, a division component 220, a candidate component 230, a presentation component 240, a selection component 250, and an identification component 260 all configured to communicate with each other (e.g., via a bus, shared memory, a switch, or a network). Any one or more of the components described herein may be implemented using hardware (e.g., one or more processors specifically configured to perform the operations described herein) or a combination of hardware and software, forming a hardware-software implemented component. For example, any component described herein may configure a processor (e.g., among one or more processors of a machine) as a special purpose machine, during the pendency of a set of operations, to perform the operations described herein for that component. Moreover, any two or more of these components may be combined into a single component, and the functions described herein for a single component may be subdivided among multiple components. Furthermore, according to various example embodiments, components described herein as being implemented within a single machine, database, or device may be distributed across multiple machines, databases, or devices.

The access component 210 receives sets of publication data on the social network system 10. In various example embodiments, the access component 210 accesses the sets of publication data via a network connection between the social network system 10 and the content insertion machine 22, where the content insertion machine 22 is implemented in a standalone or otherwise networked relationship to the social network system 10.

The division component 220 determines sets of content divisions among content pages within sets of publication data received by the access component 210. The division component 220 may identify or otherwise determine content divisions using tables of contents, content elements of the set of content pages, metadata for the content pages or the set of publication data, or any other suitable information. In identifying the set of content divisions, the division component 220 may identify sections within the content pages of the sets of publication data. In some instances, as described in more detail below, the division component 220 may determine insertion points based on the content divisions. The division component 220 may store indications of the insertion points in an index page. The index page may be stored in a database accessible by the content insertion machine 22 during execution of processes for selecting and inserting content into insertion points.

The candidate component 230 determines candidate insertion content to be considered for selection and insertion among the set of content pages of a set of publication data. The candidate insertion component may be determined based on keywords within the set of publication data, content pages, member profile data, and the insertion content. In some instances, topics represented by the keywords may be considered to identify insertion content for inclusion in the set of insertion content. The candidate component 230 may also retrieve insertion content from one or more servers upon identifying the candidate insertion content suitable for insertion into a set of publication data.

The presentation component 240 causes presentation of the content pages of the sets of publication data and insertion content to be inserted among the content pages. The presentation component 240 may cause presentations of the content pages and the insertion content in graphical representations, textual representations, or other audio/visual representations. In some embodiments, causing presentation of the content pages and the insertion content includes transmitting the content pages and the insertion content to a client device (e.g., the client device 8) via a network connection. In some instances, the content pages and the insertion content may be presented by rendering the data on a display device associated with the client device 8.

The selection component 250 selects candidate insertion content for insertion into insertion points. The selection component 250 may select the candidate insertion content based on presentation of a content page proximate to an insertion point. The candidate insertion content may be selected from a set of insertion content determined to be suitable for the set of publication data by the candidate component 230. In some instances, the selection component 250 selects candidate insertion content based on dynamic joint auctions conducted in response to presentation of one or more content pages.

The identification component 260 identifies topics for each content page of the set of publication data. The identification component 260 may use semantic analysis methods to label topics represented by content elements within the content pages. In some instances, the identification component 260 may identify topics for sections of the set of publication data including more than one content page. The identification component 260 may store topics identified for the content pages within a database, metadata, or any other suitable location accessible by the content insertion machine 22. In some instances, the identification component 260 may identify keywords, associated with the topics, which map the topics, insertion content, content pages, and members of the social network system 10.

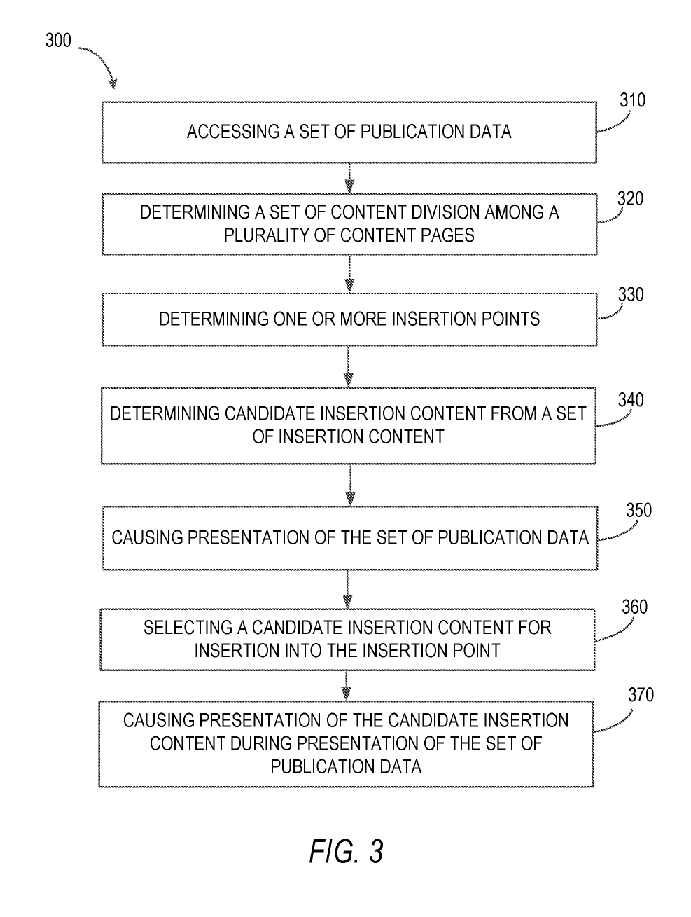

FIG. 3 is a flow diagram illustrating an example method 300 of dynamically selecting candidate content for insertion into a content presentation, consistent with various embodiments described herein. The method 300 may be performed, at least in part, by, for example, the content insertion machine 22 illustrated in FIG. 2 (or an apparatus having similar components or operative programming, such as one or more client machines or application servers).

In operation 310, the access component 210 receives a set of publication data. The publication data includes a plurality of content pages. Each content page of the plurality of content pages includes a set of content elements. In some embodiments, the access component 210 receives the set of publication data as a set of slides, such as a set of POWERPOINT, CLEARSLIDE, SLIDESHARK, or KEYNOTE slides, or any other graphical presentation slides. The plurality of content pages may be a plurality of slides within the set of slides. Each slide may include content elements which are the content of the slide, such as words, equations, images, or bullet points. The set of publication data may be received by the access component 210 based on a member uploading the set of publication data to the social network system 10 or a network-based publication system. The member may upload the set of publication data for inclusion with a plurality of publication data on the social network system 10 or network-based publication system configured for presentation to users or members of the social network system 10 or the network-based publication system.

In some embodiments, upon receipt of the set of publication data, the content insertion machine 22 may generate one or more tables or entries within the set of publication data within a database. The one or more tables may include a content page table, a keyword table, a topic table, and an insertion points table. The tables may be populated by one or more operations of the method 300, described below.

In operation 320, the division component 220 determines a set of content divisions among the plurality of content pages of the set of publication data. For each set of publication data (e.g., each slide deck) received by the access component 210, the division component 220 may determine content divisions among the slides of the slide deck. In some embodiments, content divisions may be divisions between two individual slides or between linked groups of slides (e.g., content pages). In some instances, the content divisions represent divisions between topics within the set of publication data. Topics may be contained in individual content pages (e.g., slides) or may span multiple content pages.

In some embodiments, the operation 320 may be performed by one or more sub-operations. For example, the division component 220 may initially identify a table of contents for the set of publication data and a set of sections within the table of contents. In some instances, the table of contents is represented on a content page of the set of publication data. The table of contents may also be represented within metadata of the set of publication data without being included in a specified content page. The table of contents may indicate links between content pages, topics for individual content pages or groups of content pages, and first and last content pages for linked or grouped content pages.

For each section of the set of sections, the division component 220 may identify a last content page associated with a transition between a first section and a second section of the set of sections. For example, a section may be a group of content pages associated with a single topic or concept within a broader presentation. The table of contents of the set of publication data may indicate a plurality of sections (e.g., topics) within the set of publication data and each section may have one or more associated content pages. Based on the table of contents, the division component 220 may identify last content pages representing an end to each section or topic. The last content pages may also represent a transition between two sections. The division component 220 may identify the last content page by identifying discrete sections within the table of contents, and identifying ranges of content pages within each section. The division component 220 may determine the highest page number (e.g. a content page or slide number) within a section to be the last content page of the section and thus identify the last content page associated with the transition between two sections. The last content page may thus be identified as a pre-insertion point within the set of publication data and indicating the transition between sections.

For each section of the set of sections, the division component 220 may associate a content division of the set of content divisions with the last content page. The content division may be represented as a tag or other demarcation indicating that the last content page of the section terminates the section. In some embodiments, the indication of the content division is stored in metadata. The indication of the content division may also be stored within the last content page of a section. In some instances, the indication of the content division may be stored in a separate file, distinct from the set of publication data and referenced during performance of the method 300.

In some instances, at least a portion of the content pages of the set of content pages are linked. In these instances, determining the set of content divisions may be performed using one or more sub-operations. For example, the division component 220 may identify one or more position indicators for each content page of the set of content pages. The position indicators may be associated with a position of at least one content element on the content page. For example, the position indicators may be bullet point positions on a slide of a presentation. Bullet point positions may indicate a hierarchical relationship among the content elements of a given content page. An initial bullet point position (e.g., a position proximate to a left side of the content page) may indicate a highest hierarchical level with each successive bullet point position (e.g., a position further from the left side or closer to a right side of the content page) indicating a lower hierarchical level.

The division component 220 may determine a content division based on a change in position between a final position indicator on a first content page and an initial position indicator on a second content page. For example, where the final position indicator on the first content page is a lower hierarchical position than the initial position on the second content page, the division component 220 may determine the content division between the first content page and the second content page. Where the final position indicator on the first content page is a higher hierarchical position than the initial position on the second page, the division component 220 may determine that the first and second content pages are linked and that no content division exists between the first and second content pages. In some instances, the division component 220 may also determine a content division based on numbering or other designation. For example, where content elements are identified by roman numerals, a change from “IV” to “I” may cause the division component 220 to determine a content division between the roman numerals “IV” and “I”. In some embodiments, the determination of a content division may occur where the change between numbering, designation, or position, occurs between content pages.

In operation 330, the division component 220 determines one or more insertion points corresponding to one or more content divisions of the set of content divisions. An insertion point may be positioned between content pages where a content division has been determined. For example, where a slide deck (e.g., a set of publication data) includes a fourth slide and a fifth slide, between which a content division has been identified, the division component 220 may determine an insertion point is to be positioned between the fourth slide and the fifth slide. In some embodiments, the division component 220 determines an insertion point for each content division.

In some instances, the division component 220 determines an insertion point for a portion of the one or more content divisions. The division component 220 may determine insertion points for a portion of the content divisions equal to a predetermined number of insertion points. For example, for a set of publication data including twenty content pages, four insertion points may be distributed among the five content divisions. In some embodiments, the division component 220 dynamically determines a number of insertion points for the set of publication data. The number of insertion points may be determined based on a number of content pages and a number of content divisions. For example, the division component 220 may determine a number of insertion points as a predetermined percentage of the number of identified content divisions. In some instances, the number of insertion points may be determined as a predetermined percentage of the number of content pages. The division component 220 may also include a predetermined number of insertion points and increase the number of insertion points based on a number of content divisions, the number of content pages, or any other suitable modifier.

In some embodiments, in identifying the insertion point, the division component 220 may identify a subset of content pages from the set of publication data. The division component 220 generates an index page containing links identifying positions of the set of publication data following each content page of the subset of content pages. The identified positions may be the insertion points where additional content may be inserted.

Upon receiving a plurality of sets of publication data and identifying insertion points for one or more sets of publication data of the plurality of sets of publication data, the division component 220 may train a binary classification model to detect if a position (e.g., a point between two content pages) of a set of publication data is a transition between sections of the set of publication data, such that additional content may be placed between the content page and a subsequent content page. In some example embodiments, the binary classifier model may be implemented as a support vector machine. The data used to train the binary classification model may be a set of tuples including page position, content pages, and an indication of whether the point is an insertion point. The binary classification model may consider page position, overall page number, a distance between words in a current content page and a subsequent content page and a meaning of words in the current and subsequent content pages, whether the subsequent page includes a title or a header, and unigrams of the current content page. The unigrams of the current content page may include trigger words such as “summary” or “conclusion” to indicate a termination content page of a section of the set of publication data. After the insertion points have been detected for the set of publication data, and insertion points have been labeled, the insertion points, or an indication thereof, may be stored in an insertion point table in the database associated with the set of publication data.

In operation 340, the candidate component 230 determines candidate insertion content from a set of insertion content. The candidate insertion content is determined to be inserted into the set of content pages at the one or more insertion points. Candidate insertion content may be determined based on keywords within the set of publication data and content pages, topics associated with the content pages, and/or keywords or topics of interest to or otherwise associated with a member to whom the set of publication data is being presented. The set of insertion content may include representations of other sets of publications on the social network system 10 or network-based publication system. For example, the social network system 10 or network-based publication system may have a set of varying slide decks (e.g., a plurality of sets of publication data). Each slide deck may include a representation of the slide providing information about the content or topics of the slide deck. The representations may be included in the set of insertion content.

In some embodiments, the set of insertion content includes sponsored content, advertisements, or other third party content. In these instances, the insertion content may be determined, selected, or identified based on topics or keywords of sets of publication data or content pages, topics or keywords associated with members of the social-network system 10, or combinations thereof. In some example embodiments, the set of insertion content includes supplementary content other than sponsored content or advertisements. The supplementary content may include content pages from another set of publication data, such as a content page explaining a concept in a content page prior to the insertion point. The supplementary content may also include content pages representing another set of publication data related to content elements presented on a previous content page (e.g., suggested further reading). The candidate insertion content, selected from the set of insertion content, may be retrieved from a database and loaded from the database by an advertisement server. The set of insertion content may be indexed for increased speed in selection based on matching to one or more topics or keywords. For example, within the database or an advertisement server, the set of insertion content may be indexed into an insertion content index including an inverted index and a forward index. The inverted index may map one or more keywords or topics to a list of candidate insertion content of the set of insertion content. The list of candidate insertion content may include insertion content which has been identified as targeting one or more specified keywords or topics. For example, for a first keyword, the inverted index may include a mapping between the first keyword and one or more insertion content. For a first topic, the inverted index may include a mapping between the first topic and one or more insertion content. Insertion content may be included in more than one mapping to differing topics and keywords. The forward index may map candidate insertion content to a targeted member (e.g., member) profile. The forward index may map the insertion content to characteristics of member profiles based on keywords or topics identified in a history of the member profile (e.g., topics and keywords for sets of publications which the member has previously viewed), demographic information for the member, usage statistics or characteristics for the member or the member profile, or any other suitable identifying characteristic for the member or member profile.

In some embodiments, during determination and retrieval of the candidate insertion content, a call is made by the candidate component 230 to the advertisement server or the database. The call may contain keywords or topics and a member identification associated with a specified member of the social network system 10. For example, the call may include cookie information, identification information, position of the insertion point, and an identification of the set of publication data currently being presented to the member. The advertisement server may compare the keywords and/or topics to the inverted index to retrieve one or more candidate insertion contents from the set of insertion content. The advertisement server may then iterate the forward index to determine candidate content of the retrieved one or more candidate insertion contents which targets the member based on the topics, keywords, or member profile characteristics. Although described with respect to the advertisement server determining and retrieving candidate insertion content, it should be understood that, in at least some example embodiments, the candidate component 230 may determine and retrieve the candidate insertion content using similar or the same processes.

In operation 350, the presentation component 240 causes presentation of the set of publication data including the plurality of content pages. In some embodiments, the presentation component 240 causes presentation of the set of publication data as a sequence of the plurality of content pages. The presentation component 240 may cause presentation of the set of publication data by transmitting content pages of the set of publication data via the network (e.g., the internet) to the client device 8. In some instances, the presentation component 240 may be implemented, at least in part, on the client device 8. In these situations, the presentation component 240 may directly cause presentation of the set of publication data by rendering the content pages of the set of publication data on a display device (e.g., a display or a touchscreen) of the client device 8.

In operation 360, the selection component 250 selects a candidate insertion content for insertion into the insertion point upon presenting a content page proximate to an insertion point of the one or more insertion points. In some embodiments, the candidate insertion content may be selected from the insertion content determined in the operation 340. Although described as separate operations, in some embodiments, the operation 340 may be incorporated into the operation 360 and performed after the operation 350 has been initiated and one or more content pages have been presented by the presentation component 240.

In some embodiments, candidate content which is identified as targeting the member, in the operation 340, may be selected. The candidate content may be selected based on a joint auction to determine which candidate insertion content to be presented to the member. The joint auction may be performed among different bid types. Bid types may include cost per dwell time (CPD), cost per click (CPC), or any other suitable bid type. CPD may be understood as a cost per time unit, such as a cost per second a content page was visible on the display device associated with the client device 8.

The auction may be performed based on estimated cost per impression (eCPI), the expected payoff of presenting a specified candidate insertion content to a member. In some embodiments, CPD within the auction may be calculated using Equation I:

eCPI=bid×E[dwell time|member,candidate insertion content,insertion point]

In Equation I, a regression model may be used to estimate the dwell time of the presentation of the candidate insertion content to the member when displayed in a specified insertion point. Linear regression may be used on dwell time, determining the logarithm of the dwell time, or any other suitable regression model may be employed. The regression model may be trained on historical impression data with a recorded dwell time. The historical impression data may represent presentations of the candidate insertion content to one or more members of the social network system 10 and the time (e.g., dwell time) that the candidate insertion content was visible on the display device of the client device 8 being used by the one or more members. The regression model may also be trained on member demographics, candidate insertion content unigram features, member/insertion content interaction, candidate insertion content similarity features with respect to the set of publication data, and candidate insertion content similarity features with respect to the last page of a section of the set of publication data. The regression model may take into consideration these similarities of the candidate insertion content, the member, and the set of publication data to determine the eCPI of the candidate insertion content having a CPD bid.

In some instances, the eCPI of the CPC bids within the auction may be calculated using a click prediction model using the features described above for the regression model. The click prediction model may be modeled on historical candidate insertion content impressions and click data. The eCPI of the CPC bids may be calculated using Equation II:

eCPI=bid×P(click|member,candidate insertion content,insertion point)

In at least some example embodiments, logistic regression may be used for the regression model for CPC bids. Equation II may represent eCPI as a bid multiplied by a probability of a click given the member, candidate insertion content, and insertion point.

Once the CPC and CPD bids have been converted to the eCPI scale for the candidate insertion content identified in operation 340, a unified auction can be run to find the highest eCPI. The candidate insertion content with the highest eCPI in the unified auction may be the winner of the auction and selected as the candidate insertion content for insertion into the insertion point of the set of publication data. In some embodiments, after being selected, a cost may be determined for the party associated with the selected candidate insertion content. In these instances, for CPC bids, the per click cost may be determined by Equation

$$per click cost = \frac{eCPI\_ 2}{pCTR\_ 1}$$

In Equation III, eCPI_2 is the second highest eCPI of the auction leading to selection of the candidate insertion content. pCTR_1 is a predicted click through rate of the candidate insertion content. For CPD bids, the per second cost for the party may be determined by Equation IV:

$$per second cost = \frac{eCPI\_ 2}{eDwelltime\_ 1}$$

In Equation IV, the eCPI_2 is a second highest eCPI for the auction leading to selection of the candidate insertion content. eDwelltime_1 is the expected dwell time for the candidate insertion content selected for presentation.

In operation 370, the presentation component 240 causes presentation of the candidate insertion content during presentation of the set of publication data. In some embodiments, the presentation component 240 causes presentation of the candidate insertion content in the insertion point between two of the content pages of the set of publication data. The presentation component 240 may cause presentation of the candidate insertion content by transmitting the candidate insertion content via the network (e.g., the internet) to the client device 8. In some instances, the presentation component 240 causes presentation of the candidate insertion content by causing the advertisement server to transmit or otherwise cause presentation of the candidate insertion content at the client device 8 using the network. After presenting the candidate insertion content at the client device 8, upon receiving a user interface selection or other termination indication, the presentation component 240 may terminate presentation of the candidate insertion content and continue presentation of the content pages, presentation of which was initiated in operation 350.

Once the candidate insertion content has been selected and presented, in embodiments where the candidate insertion content is an advertisement, the content insertion machine 22 may bill the party associated with or otherwise responsible for the candidate insertion content which was presented. Where the candidate insertion content is associated with a CPC bid, the content insertion machine 22 may generate and transmit a charge to the party or against a transaction account (e.g., a bank account, a credit account, or a retainer account) where the candidate insertion content was clicked or otherwise selected by the member. Clicks resulting in a charge to the transaction account may include an immediate redirect, a delayed redirect, an email transmission, or any other suitable click or interaction. Where the click is an immediate redirect, once clicked, the browser, application, or other presentation interface presenting the set of publication data and candidate insertion content at the client device 8 may be directed to a landing page of the candidate insertion content. The landing page may be a company website, a product page, or any other suitable advertisement landing page. Where the click is a delayed redirect, once clicked, the browser, application, or presentation interface is not immediately redirected to the landing page. Instead, the browser, application, or presentation interface stores a network address of the landing page. The browser, application, or presentation interface is automatically directed to the landing page, in response to storing the address, once a final content page of the set of publication data has been presented. Where the click is an email transmission, once clicked, the content insertion machine 22 may generate and transmit an email to an email address associated with the member in the social network system 10. The email generated and transmitted by the content insertion machine 22 may include a rendered image of the landing page associated with the candidate insertion content. The email may also include a link configured to direct the browser, application, or presentation interface of the client device 8 to access the network address of the landing page upon receiving a selection of the link.

Where the candidate insertion content is associated with a CPD bid, the content insertion machine 22 may generate and transmit a charge to the party or against a transaction account where the candidate insertion content was presented. In some embodiments, the party is charged based on a time the candidate insertion content is visible at the display device of the client device 8. In some instances, a minimum charge may be applied for presentation of the candidate insertion content up to a predetermined period of time (e.g., an initial two seconds). Once the predetermined period of time elapses, the content insertion machine 22 may charge the party at the rate described above for each second the candidate insertion content is presented in excess of the predetermined time period.

In some embodiments, based on causing presentation of the candidate insertion content, the presentation component 240 may determine a presentation time for the candidate insertion content. The presentation time represents a time period during which the candidate insertion content was visible prior to presentation of a subsequent content page of the set of content pages. The presentation component 240 may pass an indication of the presentation time to the identification component 260 such that the candidate component 230 associates the presentation time with the candidate insertion content.

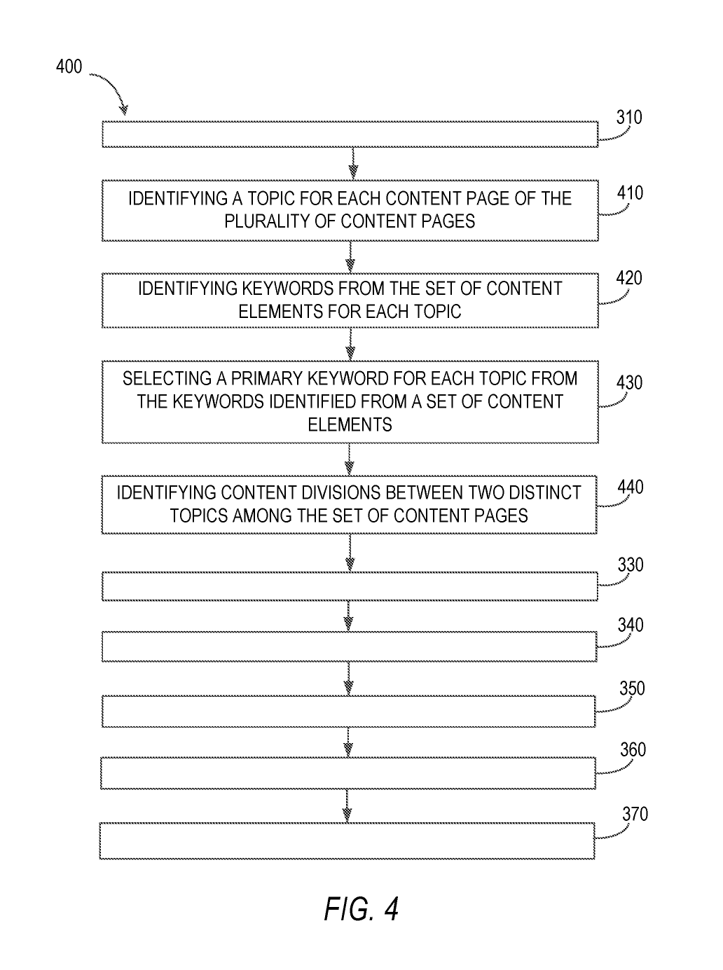

FIG. 4 is a flow diagram illustrating an example method 400 of dynamically selecting candidate content for insertion into a content presentation, consistent with various embodiments described herein. The method 400 may be performed, at least in part, by, for example, the content insertion machine 22 illustrated in FIG. 2 (or an apparatus having similar components, such as one or more client machines or application servers). In some embodiments, the method 400 includes one or more operations from the method 300. In some instances, as shown in FIG. 4, the method 400 is performed after the operation 310. After performance of the method 400, the remaining elements of the method 300, operations 330-370 may be performed.

In operation 410, the identification component 260 identifies a topic for each content page of the plurality of content pages based on the set of content elements. In some example embodiments, the identification component 260 identifies the topic based on one or more topic detection algorithm. For example, the identification component 260 may use probabilistic latent semantic analysis (PLSA) or Latent Dirichlet allocation (LDA) to automatically label one or more of the topics represented by the content elements. The output of the topic labelling may indicate a content page number and one or more topics. The one or more topics may include one or more keywords for each topic and a numerical indication of a match percentage of the content elements and the topic. For example, a content page may be indicated as having a topic “big data” with a numerical indication of “50%” and “e-commerce” with a numerical indication of “35%.” The identification component 260 may store the topics identified for each content page within a database. For example, the topics may be stored in metadata or a data table associated with the set of publication data and linking or otherwise associating the identified topics, the content page, and the set of publication data.

In operation 420, the identification component 260 identifies keywords from the set of content elements for each topic. In some example embodiments, the identification component 260 takes a keyword having a highest numerical indication for each content page. The identification component 260 may also identify additional keywords for the content pages. The identification component 260 may identify the additional keywords automatically using conditional random fields (CRF) for phrase segmentation and term frequency-inverse document frequency (tf-idf) for importance score computation. The identified keywords may be stored in the database associated with the content page and the set of publication data. For example, the identified keywords may be stored in metadata or a data table associated with the set of publication data and indicating a mapping or other association between the keywords and one or more specified content pages for which the keywords were identified or added.

In operation 430, the identification component 260 selects a primary keyword for each topic from the keywords identified from the set of content elements. In some instances, the identification component 260 selects the primary keyword and topic for each content page. Where the content page for which the topic and keyword are identified is a single content page representing a section, not linked to another content page, the section may be associated with the topic and keywords. Where the content page is linked to one or more content pages to form a section, the identification component 260 may determine a topic and one or more keyword applicable to all of the content pages of the section.

In operation 440, the division component 220 identifies content divisions between two distinct topics among the set of content pages. In some embodiments, the division component 220 identifies the content divisions based on the primary keyword selected for each content page. For example, where a first topic and first keywords are identified for a content page or for a subset of content pages, the division component 220 may identify a content division between the content page or the subset of content pages associated with the first topic and a content page or subset of content pages associated with a second topic distinct from the first topic.

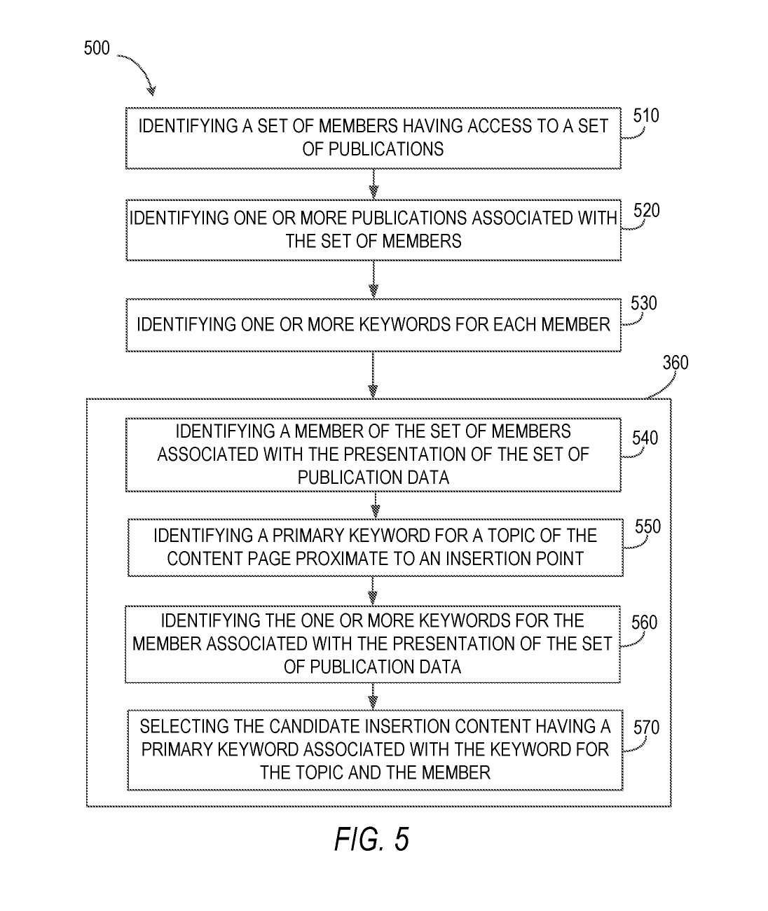

FIG. 5 is a flow diagram illustrating an example method 500 of dynamically selecting candidate content for insertion into a content presentation, consistent with various embodiments described herein. The method 500 may be performed, at least in part, by, for example, the content insertion machine 22 illustrated in FIG. 2 (or an apparatus having similar components, such as one or more client machines 8 or application servers). In some embodiments, the method 500 includes one or more operations from the methods 300 or 400. For example, the method 500 includes operations 310-350. The operations of the method 500 may be performed during or as a set of sub-operations of one or more operations of the methods 300 or 400. As shown in FIG. 5, the operations of the method 500 are performed as sub-operations of the operation 360.

In operation 510, the identification component 260 identifies a set of members having access to the set of publication data. The identification component 260 may identify the set of members based on membership data of the social network system 10. In some embodiments, the identification component 260 may identify the set of members based on a permission within the social network system 10 to access the publication data. For example, the plurality of sets of publication data may be included in a membership package or permission in addition to membership in the social network system 10.

In operation 520, the identification component 260 identifies one or more publications associated with the set of members. The association of the one or more publications with a member may be generated based on the member having viewed the one or more publications. As such, the association of a publication data and a member indicates the publication data is part of a viewing history of the member. The identification component 260 may identify one or more publications associated with each member by parsing history data associated with a member profile on the social network system 10. The history data may include publication data viewed by the member as well as candidate insertion content presented to the member within the viewed publication data.

In operation 530, the identification component 260 identifies one or more keywords for each member of the set of members based on the one or more publications associated with (e.g., viewed by) the member. For example, the identification component 260 may identify keywords for a member based on the keywords identified for the one or more publications with which the member is associated. In some instances, the identification component 260 identifies a keyword for association with a member where the member viewed the publication data without terminating the presentation prior to a final content page of the publication data. The one or more keywords for the publication data may be selected and associated with the member based on completion of the presentation.

In some embodiments, the operation 360 may include performance of one or more operations of the method 500. In these instances, each candidate insertion content item is associated with a primary keyword. As shown in FIG. 5, the operation 360 may include operation 540. In operation 540, the selection component 250 identifies a member of the set of members associated with the presentation of the set of publication data. As described above, the association between the member and the set of publication data may represent viewing of the publication data by the member such that an indication of the publication data is stored in a history of the member.

In operation 550, the selection component 250 identifies the primary keyword for the topic of the content page proximate to the insertion point. In some embodiments, the primary keyword for each topic and each content page may be identified as the keyword having the highest numeric indicator, as described above with respect to operation 410.

In operation 560, the selection component 250 identifies the one or more keywords for the member associated with the presentation of the set of publication data. The one or more keywords may be the primary keyword for each topic or content page of publications viewed by the member. In some embodiments, the one or more keywords may be identified as a subset of keywords for the content pages and topics viewed by the member. For example, in some instances, selection component 250 may initially identify the one or more keywords for the member based on an initial set of publication data viewed by the member. With each subsequent set of publication data and insertion content viewed by the member, the selection component 250 may modify the one or more keywords to represent keywords and topics most viewed by the member. In some embodiments, the one or more keywords may be modified by keywords from sets of publication data which the member viewed to completion.

In operation 570, the selection component 250 selects the candidate insertion content having a primary keyword associated with the primary keyword for the topic of the content page and at least one keyword of the one or more keywords for the member. Upon reaching the content page of the set of publication data immediately preceding an insertion point (e.g., a pre-insertion point page), the selection component 250 selects the candidate insertion content from the set of insertion content which has a keyword or primary keyword in the inverted index which matches one or more of the keywords associated with the member in the forward index.

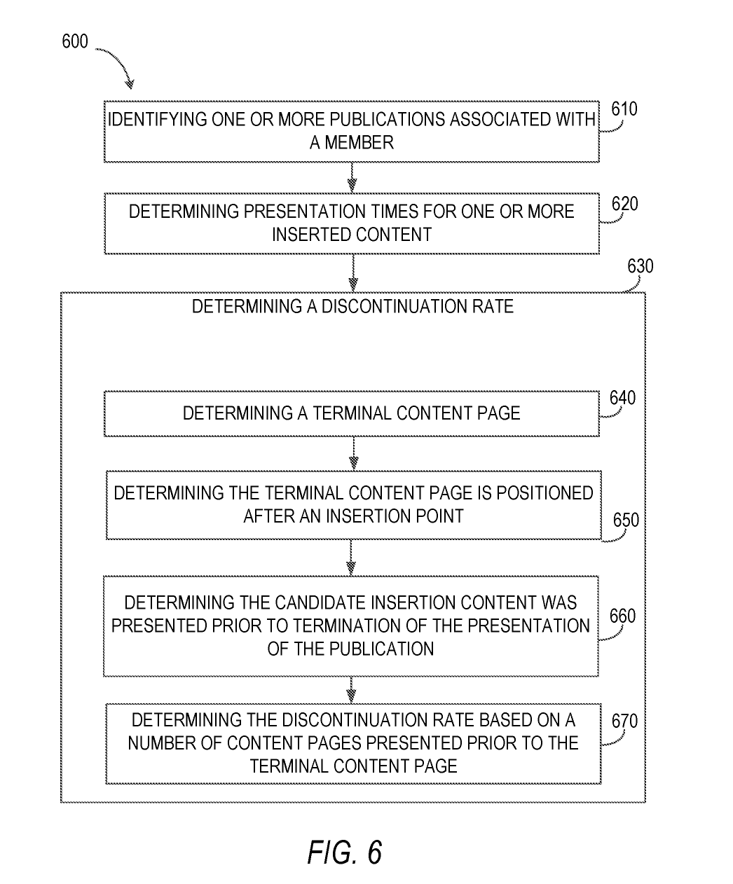

FIG. 6 is a flow diagram illustrating an example method 600 of dynamically selecting candidate content for insertion into a content presentation, consistent with various embodiments described herein. The method 600 may be performed, at least in part, by, for example, the content insertion machine 22 illustrated in FIG. 2 (or an apparatus having similar components, such as one or more client machines or application servers). In some embodiments, the method 600 includes one or more operations from the methods 300, 400, or 500. For example, the method 600 may include operations 310-350. The operations of the method 600 may be performed during or as a set of sub-operations of one or more operations of the method 300. In some embodiments, the operations of the method 600 may be performed as sub-operations of the operation 360 of method 300. In these instances, the operations of the method 600 may be performed to provide input for selecting from among a set of candidate insertion content by removing content which may cause a viewer from terminating viewing of a set of publication data.

In operation 610, the selection component 250 identifies one or more publications associated with a member. The association of the one or more publications with the member may be generated based on the member having viewed the one or more publications. The selection component 250 may identify the one or more publications based on inclusion of an identifier for the one or more publications within the member profile, history data, or other data associated with the member on the social network system 10.

In operation 620, the selection component 250 determines presentation times for one or more piece of inserted content presented within the one or more publications. In some example embodiments, the presentation times represent a duration for each of the one or more pieces of inserted content during which the inserted content was visible on the display device of the client device 8 of the member. In some instances, the presentation time may be below a predetermined presentation time for inserted content. For example, where the inserted content has an intended presentation time of fifteen seconds, the presentation time within the history of the member may indicate presentation of the inserted content for only five seconds.

In operation 630, the selection component 250 determines a discontinuation rate based on the inserted content and the content pages of the one or more publications. The discontinuation rate may represent a percentage of inserted content items which were presented to completion of the predetermined presentation time for the specified inserted content. In some embodiments, the discontinuation rate is a percentage of inserted content which were presented for more than a predetermined period of time regardless of a time duration intended for presentation of the inserted content. In some instances, the discontinuation rate is a percentage of instances where inserted content is presented and at least a subsequent content page is presented or presentation of the set of publication data is completed.

In some embodiments, operation 630 may be performed using one or more sub-operations. For example, in operation 640, for each publication of the one or more publications associated with the member, the selection component 250 determines a terminal content page at which presentation of the publication was terminated by the member. The terminal content page may be a last content page of the set of content pages of the publication data or may be a content page at which the member ceased viewing the publication data prior to completion of the last content page. The selection component 250 may generate an indication of whether the terminal content page is the same as the last content page of the publication data along with the determination of the terminal content page.

In operation 650, the selection component 250 determines that the terminal content page is positioned after an insertion point. The insertion point may be identified based on the index page, described with respect to operation 330, which indicates the insertion points in a set of publication data. The selection component 250 may determine content page numbers immediately prior to and after the insertion point, based on the index page, and identify a page number for the terminal content page. The selection component 250 compares the page number for the terminal content page and the page numbers preceding and following the insertion points to determine whether the terminal content page is positioned after the insertion point, and if the terminal content page is proximate to an insertion point.

In operation 660, the selection component 250 determines the candidate insertion content presented prior to termination of the presentation of the publication. In some embodiments, where the terminal content page is proximate (e.g., within one to three content pages) to and following the insertion point, the selection component 250 identifies the candidate insertion content presented in the insertion point. In some instances, the selection component 250 determines the candidate insertion content by parsing the history of the member to identify an insertion content identification associated with the set of publication data and the insertion point within the history of the member.

In operation 670, the selection component 250 determines the discontinuation rate based on a number of content pages presented prior to the terminal content page for each publication. In some example embodiments, the discontinuation rate may be a function of a percentage of content pages viewed in a given set of publication data prior to termination of the presentation of the set of publication data. Where the selection component 250 determines discontinuation rates based on a percentage of viewed content slides within a set of publication data, the selection component 250 may associate the discontinuation rate with one or more of the keywords of the content pages or the set of publication data. For example, where a set of publication data was terminated as a terminal content page representing a change from a first topic or keyword to a second topic or keyword for the set of publication data, the discontinuation rate may be associated with the second topic or keyword.

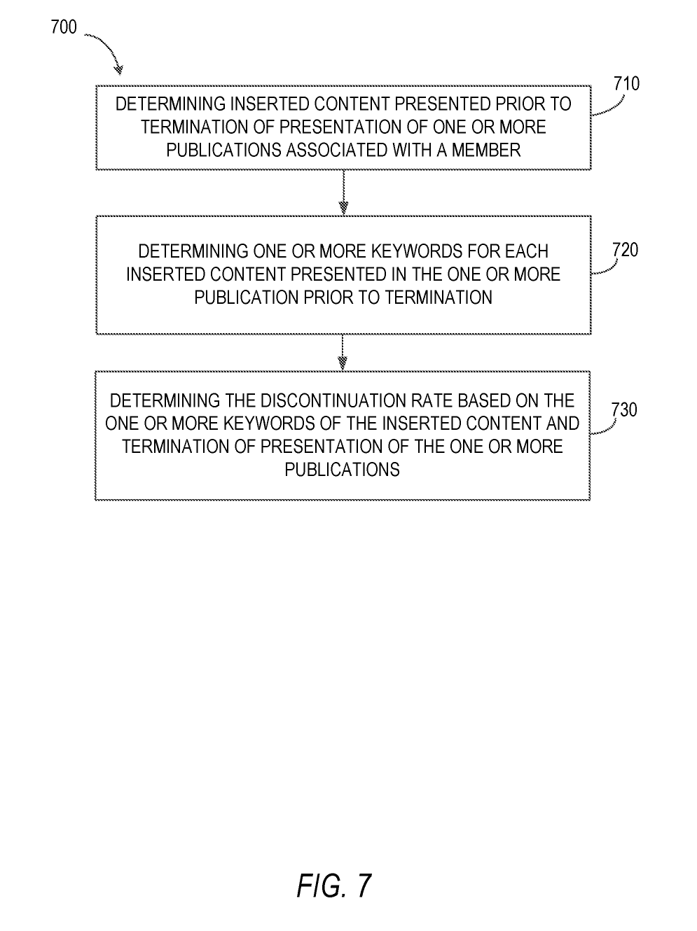

FIG. 7 is a flow diagram illustrating an example method 700 of dynamically selecting candidate content for insertion into a content presentation, consistent with various embodiments described herein. The method 700 may be performed, at least in part, by, for example, the content insertion machine 22 illustrated in FIG. 2 (or an apparatus having similar components, such as one or more client machines or application servers). In some embodiments, the method 700 includes one or more operations from the methods 300, 400, 500, or 600. For example, the method 700 may be performed in conjunction with the method 600.

In operation 710, for each member, the selection component 250 determines inserted content presented prior to termination of presentation of the one or more publications associated with the member. The inserted content may be one or more pieces of candidate insertion content which was presented to the member during presentation of a set of publication data received and processed by the content insertion machine 22, the social network system 10, or the network-based publication system. In some embodiments, the inserted content may be understood as a history of content which has previously been inserted into presentations (e.g., slide decks) viewed by the member.

In operation 720, the selection component 250 determines one or more keywords for each piece of inserted content presented in the one or more publications prior to termination. The selection component 250 may determine the one or more keywords from a keyword table associated with each piece of insertion content of the set of insertion content within the social network system 10. The selection component 250 may determine the one or more keywords by accessing the keyword table and parsing or otherwise crawling the keyword table for keywords linked, mapped, or otherwise associated with the inserted content identified in operation 710.

In operation 730, the selection component 250 determines the discontinuation rate based on the one or more keywords of the inserted content and termination of presentation of the one or more publications. The discontinuation rate may be determined as a number of times the presentation of publication data was terminated after being presented with inserted content associated with specified keywords. For example, where a member discontinues a presentation of content pages nine out of ten times a specified inserted content is presented or inserted content associated with one or more specified keywords, the discontinuation rate may be ninety percent for the specified insertion content or the one or more specified keywords.

In some embodiments, after determining the discontinuation rate for a member of the social network system 10, the selection component 250 may preclude candidate insertion content implicated by the discontinuation rate (e.g., candidate insertion content having keywords or topics similar to those determined in operation 730) from being selected for inclusion in the set of publication data. The content insertion machine 22 may generate a discontinuation model based on the one or more keywords determined in operation 730. The discontinuation model may identify a probability of discontinuation of presentation of a set of publication data after an insertion point based on a measure of interruptiveness of an inserted candidate insertion content. In some instances, the probability of discontinuation is a measure of how likely a given member or member is to stop reading or viewing a presentation at any given insertion point after being presented with a specified candidate insertion content. In some embodiments, the discontinuation model may be a binary classification model, such as a logistic regression model.

The discontinuation model may be trained on data including a similarity between a candidate insertion content and a set of publication data, a similarity between a candidate insertion content and a set of publication data prior to a given insertion point, an average linger time per content page that a specified member has spent up to the insertion point, a position of the insertion point relative to the number of content pages included in the set of publication data, a historical overall discontinuation rate of a specified member, a historical overall discontinuation rate for a specified candidate insertion content, and a historical overall discontinuation rate at a specified insertion point. The historical overall discontinuation rate for the specified insertion point may be identified for a specified member or for a specified set of publication data. Based on the discontinuation model, if a candidate insertion content is likely to cause discontinuation of presentation of a set of publication data if displayed at a specified insertion point, one or more of the selection component 250 and the presentation component 240 precludes insertion of the specified candidate insertion content.

In some embodiments, candidate insertion content may be processed by the discontinuation model in operation 340. Where the candidate insertion content has a probability rate above a predetermined threshold, the candidate component 230 may remove the candidate insertion content from the set of insertion content considered for presentation within the set of publication data. In some instances, the candidate insertion content may be processed by the discontinuation model in operation 360. Where the candidate insertion content has a probability rate above the predetermined threshold, the selection component 250 precludes selection of the candidate insertion content. In some instances, precluding selection of the candidate insertion content may be performed by or result in selection of alternative candidate insertion content determined in operation 340 by the candidate component 230.

The discontinuation model may determine probability rates using Equation V:

P(discontinuation|member,candidate insertion content|insertion point)

The discontinuation model may compare the result of Equation V to a predetermined threshold, as described above. The predetermined threshold may be a heuristically determined threshold value, a threshold value specific to the member being presented the set of publication data, a threshold value specific to the insertion point within the set of publication data at which the candidate insertion content is to be displayed, a threshold value specific to the candidate insertion content, combinations thereof, or any other suitable threshold value.

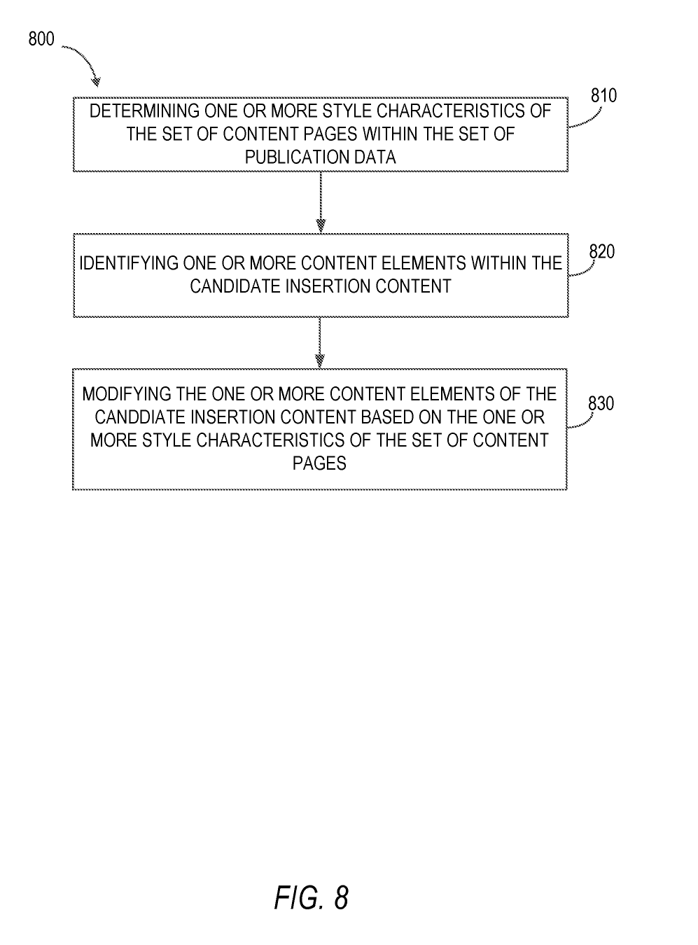

FIG. 8 is a flow diagram illustrating a method 800 of dynamically selecting candidate content for insertion into a content presentation, consistent with various embodiments described herein. The method 800 may be performed, at least in part, by, for example, the content insertion machine 22 illustrated in FIG. 2 (or an apparatus having similar components, such as one or more client machines or application servers). In some embodiments, the method 800 includes one or more operations from the method 300. For example, the operation may be performed in response to completion of the operation 360 and prior to performance of the operation 370.

In operation 810, the presentation component 240 determines one or more style characteristics of the set of content pages within the set of publication data. In some embodiments, the one or more style characteristics include a color histogram, a color scheme, a template selection, an element distribution, a border type, and other characteristics representing the graphical presentation of the set of content pages within the set of publication data.

In operation 820, the presentation component 240 identifies one or more content elements within the candidate insertion content, upon selection of the candidate insertion content in operation 360. In some embodiments, the candidate insertion content is initially received by the content insertion machine 22 using a specified template selected from a set of templates. The candidate insertion content may also be received having a specified color histogram. The color histogram may represent a color scheme for the candidate insertion content.

In operation 830, the presentation component 240 modifies the one or more content elements of the candidate insertion content based on the one or more style characteristics of the set of content pages. In some instances, the content elements and the characteristics (e.g., template, color histogram, and color scheme) are compared with the one or more style characteristics of the set of publication data into which the candidate insertion content is being inserted. The one or more content elements may be modified to match or approximate the one or more style characteristics of the set of content pages. For example, where the one or more style characteristics of the set of content pages have a first color scheme or color histogram and the candidate insertion content has a second color scheme or color histogram, the one or more content elements of the candidate insertion content may be modified from the second color scheme to the first color scheme. In some instances, the one or more content element of the candidate insertion content is modified to approximate the first color scheme without matching the first color scheme. For example, a hue, intensity, saturation, or value contributing to the second color scheme may be modified to coordinate with the first color scheme without changing all of the values contributing to the second color scheme. The comparison of the color schemes or color histograms may be measured based on K-L divergence.

In some embodiments, the one or more content elements of the candidate insertion content may be renderable within a set of templates having a set of color schemes and predetermined layouts. Modification of the one or more content elements of the candidate insertion content may include matching the template of the content pages of the set of publication data with a selected template of the set of templates for the candidate insertion content. The modification may also approximate the template of the content pages with a template of the candidate insertion content. The approximation may be based on a comparison of a color scheme or color histogram of the template used for the content pages and the set of templates into which the candidate insertion content may be rendered. The comparison of the color scheme or color histogram may be performed using K-L divergence and the closest template may be selected such that the candidate insertion content appears to be native to the set of content pages.

The various operations of the example methods described herein may be performed, at least partially, by one or more processors that are temporarily configured (e.g., by software instructions) or permanently configured to perform the relevant operations. Whether temporarily or permanently configured, such processors may constitute processor-implemented components or objects that operate to perform one or more operations or functions. The components and objects referred to herein may, in some example embodiments, comprise processor-implemented components and/or objects.

Similarly, the methods described herein may be at least partially processor-implemented. For example, at least some of the operations of a method may be performed by one or more processors or processor-implemented components. The performance of certain operations may be distributed among the one or more processors, not only residing within a single machine or computer, but deployed across a number of machines or computers. In some example embodiments, the processor or processors may be located in a single location (e.g., within a home environment, an office environment or at a server farm), while in other embodiments the processors may be distributed across a number of locations.

The one or more processors may also operate to support performance of the relevant operations in a “cloud computing” environment or within the context of “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs)).

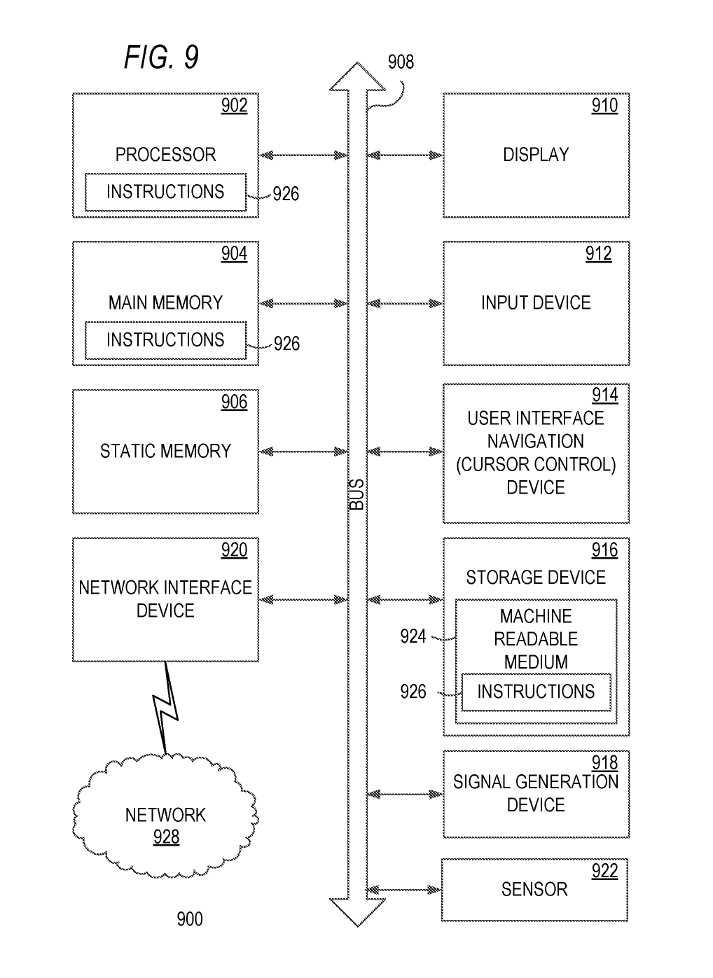

FIG. 9 is a block diagram of a machine in the form of a computing device within which a set of instructions, for causing the machine to perform any one or more of the methodologies discussed herein, may be executed. For example, the computing device may be a server functioning as the content insertion machine 22. In some instances, the computing device may be a set of similar computing devices storing instructions capable of configuring a processor of the computing device as one or more of the components (hardware-software implemented components) described above. The configuration of a component, even for a period of time, causes the computing device to act as a special purpose computing device for performing one or more operations associated with the component, as described in the present disclosure. In some embodiments, the computing device may function as the social network system 10 with portions (e.g., hardware and instructions) partitioned to function as one or more of the components, interfaces, or systems described above during specified operations associated with those aspects of the components, interfaces, and systems.

In alternative embodiments, the machine operates as a standalone device or may be connected (e.g., networked) to other machines. In a networked deployment, the machine may operate in the capacity of a server or a client machine in a client-server network environment, or as a peer machine in peer-to-peer (or distributed) network environment. In a various embodiments, the machine will be a server computer, however, in alternative embodiments, the machine may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU) or both), a main memory 904 and a static memory 906, which communicate with each other via a bus 908. The computer system 900 may further include a display unit 910, an alphanumeric input device 912 (e.g., a keyboard), and a user interface (UI) navigation device 914 (e.g., a mouse). In one embodiment, the display, input device and cursor control device are a touch screen display. The computer system 900 may additionally include a storage device 916 (e.g., drive unit), a signal generation device 918 (e.g., a speaker), a network interface device 920, and one or more sensors 922, such as a global positioning system sensor, compass, accelerometer, or other sensor.

The storage device 916 includes a machine-readable medium 924 on which is stored one or more sets of instructions and data structures (e.g., software 926) embodying or utilized by any one or more of the methodologies or functions described herein. The software 926 (e.g. processor executable instructions) may also reside, completely or at least partially, within the main memory 904 (e.g., non-transitory machine-readable storage medium) and/or within the processor 902 during execution thereof by the computer system 900, the main memory 904 and the processor 902 also constituting machine-readable media 924.

While the machine-readable medium 924 is illustrated in an example embodiment to be a single medium, the term “machine-readable medium” may include a single medium or multiple media (e.g., a centralized or distributed database, and/or associated caches and servers) that store the one or more instructions 926. The term “machine-readable medium” shall also be taken to include any tangible medium that is capable of storing, encoding or carrying instructions 926 for execution by the machine and that cause the machine to perform any one or more of the methodologies of the present disclosure, or that is capable of storing, encoding or carrying data structures utilized by or associated with such instructions 926. The term “machine-readable medium” shall accordingly be taken to include, but not be limited to, solid-state memories, and optical and magnetic media. Specific examples of machine-readable media 924 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

The software 926 may further be transmitted or received over a communications network 928 using a transmission medium via the network interface device 920 utilizing any one of a number of well-known transfer protocols (e.g., hypertext transfer protocol (HTTP)). Examples of communication networks include a local area network (“LAN”), a wide area network (“WAN”), the Internet, mobile telephone networks, plain old telephone (POTS) networks, and wireless data networks (e.g., Wi-Fi® and WiMax® networks). The term “transmission medium” shall be taken to include any intangible medium that is capable of storing, encoding or carrying instructions 926 for execution by the machine, and includes digital or analog communications signals or other intangible medium to facilitate communication of such software.

Although embodiments have been described with reference to specific examples, it will be evident that various modifications and changes may be made to these embodiments without departing from the broader scope of the inventive concepts of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

What is claimed is:

1. A method, comprising:
receiving, at a server, a set of publication data including a plurality of content pages, each content page of the plurality of content pages including a set of content elements;
determining, by one or more processors of the server, a set of content divisions among the plurality of content pages;
determining one or more insertion points corresponding to one or more content divisions of the set of content divisions;
based on the set of content elements and the one or more insertion points, determining candidate insertion content from a set of insertion content for insertion to be inserted into the set of content pages at the one or more insertion points;
causing presentation of the set of publication data including the plurality of content pages;
upon presenting a content page proximate to an insertion point of the one or more insertion points, selecting a candidate insertion content item for insertion into the insertion point; and
causing presentation of the candidate insertion content during presentation of the set of publication data.

2. The method of claim 1, wherein determining the set of content divisions further comprises:
based on the set of content elements, identifying a topic for each content page of the plurality of content pages;
identifying keywords from the set of content elements for each topic;
selecting a primary keyword for each topic from the keywords identified from the set of content elements; and
identifying content divisions between two distinct topics among the set of content pages.

3. The method of claim 2, further comprising:
identifying a set of members having access to the set of publication data;
identifying one or more publications associated with the set of members, the association of the one or more publications with a member generated based on the member having viewed the one or more publications; and
identifying one or more keywords for each member of the set of members based on the one or more publications associated with the set of members.

4. The method of claim 3, wherein each candidate insertion content item is associated with a primary keyword and wherein selecting a candidate insertion content item further comprises:
identifying a member of the set of members associated with the presentation of the set of publication data;
identifying the primary keyword for the topic of the content page proximate to the insertion point;
identifying the one or more keywords for the member associated with the presentation of the set of publication data; and
selecting the candidate insertion content having a primary keyword associated with the primary keyword for the topic of the content page and at least one keyword of the one or more keywords for the member.

5. The method of claim 1, wherein determining the set of content divisions further comprises:
identifying a table of contents for the set of publication data;
identifying a set of sections within the table of contents;
for each section of the set of sections, identifying a last content page associated with a transition between a first section and a second section of the set of sections; and
for each section of the set of sections, associating a content division of the set of content divisions with the last content page.

6. The method of claim 1, wherein at least a portion of the content pages of the set of content pages are linked and wherein determining the set of content divisions further comprises:
identifying one or more position indicators for each content page of the set of content pages, the position indicators associated with a position of at least one content element on the content page; and
determining a content division based on a change in position between a final position indicator on a first content page and an initial position indicator on a second content page.

7. The method of claim 1, further comprising:
based on causing presentation of the candidate insertion content, determining a presentation time for the candidate insertion content, the presentation time representing a time period during which the candidate insertion content was visible prior to presentation of a subsequent content page of the set of content pages; and
associating the presentation time with the candidate insertion content.

8. The method of claim 1, further comprising:
identifying one or more publications associated with a member, the association of the one or more publications with the member being generated based on the member having viewed the one or more publications;
determining presentation times for one or more inserted content presented within the one or more publications; and
based on the inserted content and the content pages of the one or more publications, determining a discontinuation rate.

9. The method of claim 8, wherein determining the discontinuation rate for the member further comprises:
for each publication of the one or more publications associated with the member, determining a terminal content page at which presentation of the publication was terminated by the member;
for each publication of the one or more publications, determining that the terminal content page is positioned after an insertion point;
for each publication of the one or more publications, determining the candidate insertion content presented prior to termination of the presentation of the publication; and
determining the discontinuation rate based on a number of content pages presented prior to the terminal content page for each publication.

10. The method of claim 8, wherein determining the discontinuation rate further comprises:
for each member, determining inserted content presented prior to termination of presentation of the one or more publications associated with the member;
determining one or more keywords for each inserted content item presented in the one or more publications prior to termination; and
determining the discontinuation rate based on the one or more keywords of the inserted content and termination of presentation of the one or more publications.

11. The method of claim 1, further comprising:
determining one or more style characteristics of the set of content pages within the set of publication data;
upon selection of the candidate insertion content, identifying one or more content elements within the candidate insertion content; and
modifying the one or more content elements of the candidate insertion content based on the one or more style characteristics of the set of content pages.

12. A system, comprising:
one or more processors; and
a non-transitory processor-readable storage medium comprising processor executable instructions that, when executed by the one or more processors, causes the one or more processors to perform operations comprising:
receiving, at a server, a set of publication data including a plurality of content pages, each content page of the plurality of content pages including a set of content elements;
determining, by one or more processors of the server, a set of content divisions among the plurality of content pages;
determining one or more insertion points corresponding to one or more content divisions of the set of content divisions;
based on the set of content elements and the one or more insertion points, determining candidate insertion content from a set of insertion content for insertion to be inserted into the set of content pages at the one or more insertion points;
causing presentation of the set of publication data including the plurality of content pages;
upon presenting a content page proximate to an insertion point of the one or more insertion points, selecting a candidate insertion content item for insertion into the insertion point; and
causing presentation of the candidate insertion content during presentation of the set of publication data.

13. The system of claim 12, wherein determining the set of content divisions further comprises:
based on the set of content elements, identifying a topic for each content page of the plurality of content pages;
identifying keywords from the set of content elements for each topic;
selecting a primary keyword for each topic from the keywords identified from the set of content elements; and
identifying content divisions between two distinct topics among the set of content pages.

14. The system of claim 13, wherein the operations further comprise:
identifying a set of members having access to the set of publication data;
identifying one or more publications associated with the set of members, the association of the one or more publications with a member generated based on the member having viewed the one or more publications; and
identifying one or more keywords for each member of the set of members based on the one or more publications associated with the set of members.

15. The system of claim 14, wherein each candidate insertion content item is associated with a primary keyword and wherein selecting a candidate insertion content item further comprises:
identifying a member of the set of members associated with the presentation of the set of publication data;
identifying the primary keyword for the topic of the content page proximate to the insertion point;
identifying the one or more keywords for the member associated with the presentation of the set of publication data; and
selecting the candidate insertion content item having a primary keyword associated with the primary keyword for the topic of the content page and at least one keyword of the one or more keywords for the member.

16. A non-transitory processor-readable storage medium comprising processor executable instructions that, when executed by one or more processors, causes the one or more processors to perform operations comprising:
receiving, at a server, a set of publication data including a plurality of content pages, each content page of the plurality of content pages including a set of content elements;
determining, by one or more processors of the server, a set of content divisions among the plurality of content pages;
determining one or more insertion points corresponding to one or more content divisions of the set of content divisions;
based on the set of content elements and the one or more insertion points, determining candidate insertion content from a set of insertion content for insertion to be inserted into the set of content pages at the one or more insertion points;
causing presentation of the set of publication data including the plurality of content pages;
upon presenting a content page proximate to an insertion point of the one or more insertion points, selecting a candidate insertion content item for insertion into the insertion point; and
causing presentation of the candidate insertion content during presentation of the set of publication data.

17. The non-transitory processor-readable storage medium of claim 16, wherein determining the set of content divisions further comprises:
based on the set of content elements, identifying a topic for each content page of the plurality of content pages;
identifying keywords from the set of content elements for each topic;
selecting a primary keyword for each topic from the keywords identified from the set of content elements; and
identifying content divisions between two distinct topics among the set of content pages.

18. The non-transitory processor-readable storage medium of claim 17, wherein the operations further comprise:
identifying a set of members having access to the set of publication data;
identifying one or more publications associated with the set of members, the association of the one or more publications with a member generated based on the member having viewed the one or more publications; and
identifying one or more keywords for each member of the set of members based on the one or more publications associated with the set of members.

19. The non-transitory processor-readable storage medium of claim 18, wherein each candidate insertion content item is associated with a primary keyword and wherein selecting candidate insertion content further comprises:
identifying a member of the set of members associated with the presentation of the set of publication data;
identifying the primary keyword for the topic of the content page proximate to the insertion point;
identifying the one or more keywords for the member associated with the presentation of the set of publication data; and
selecting the candidate insertion content having a primary keyword associated with the primary keyword for the topic of the content page and at least one keyword of the one or more keywords for the member.

20. The non-transitory processor-readable storage medium of claim 16, wherein the operations further comprise:
determining one or more style characteristics of the set of content pages within the set of publication data;
upon selection of the candidate insertion content, identifying one or more content elements within the candidate insertion content; and
modifying the one or more content elements of the candidate insertion content based on the one or more style characteristics of the set of content pages.
